(19) United States
(12) Patent Application Publication
(10) Pub. No.: US 2005/0133066 A1
(43) Pub. Date: Jun. 23, 2005

(54) Substrate treating method and apparatus

(75) Inventor: Hiroaki Takahashi, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/013,748

(22) Filed: Dec. 16, 2004

(30) Foreign Application Priority Data
Dec. 22, 2003 (JP) 2003-424896

(51) Int. Cl. B08B 3/02

(52) U.S. Cl. 134/25.4; 134/34; 134/36; 134/111; 134/186

(57) ABSTRACT

In a substrate treating apparatus for performing cleaning treatment by what is called QDR method for substrates immersed in a treating tank, CO₂-dissolved water having carbon dioxide dissolved in deionized water by a gas-liquid mixer is sprayed from nozzles to the substrates. CO₂-dissolved water has low specific resistance, and is effective to prevent electrification of surfaces of the substrates when colliding with and contacting the surfaces of the substrates. Thus, the cleaning treatment is performed without leaving the substrates electrically charged.

### BACKGROUND OF THE INVENTION

(1) Field of the Invention

This invention relates to a substrate treating method and apparatus for cleaning semiconductor substrates, glass substrates for liquid crystal displays, glass substrates for photomasks, or substrates for optical disks (hereinafter called simply “substrates”).

(2) Description of the Related Art

Conventionally, a quick dump rinse method (hereinafter called QDR method) is employed as one of the methods of cleaning substrates after chemical treatment. FIG. 1 is a view showing a procedure of cleaning treatment by QDR method. An example of cleaning treatment by QDR method will be described briefly with reference to FIG. 1.

<Loading Cin>

First, chemically treated substrates or wafers W are loaded into a treating tank 1.

<Step S1>

The wafers W are immersed and cleaned in deionized water supplied to the bottom of the treating tank 1 and over-flowing the tank 1.

<Step S2>

Subsequently, the whole quantity of deionized water in the treating tank 1 is quickly drained from the bottom of the tank 1.

<Step S3>

At this time, deionized water is sprayed toward the wafers W from nozzles 51 arranged above the treating tank 1.

<Step S4>

While deionized water is sprayed, deionized water is again poured into the treating tank 1 at the bottom thereof until the treating tank 1 is filled with the deionized water.

<Step S5>

The spraying of deionized water from the nozzles 51 is stopped, but the immersion cleaning of wafers W is continued.

<Unloading Cout>

When the cleaning treatment is completed, the wafers W are withdrawn up from the treating tank 1.

With this cleaning method, the deionized water contaminated by chemicals, impurities (particles) and the like separated from the wafers W is quickly drained from the treating tank 1. The deionized water contaminated is not allowed to remain in the treating tank 1, so that the particles and the like never adhere back to the wafers W. Fresh deionized water not contaminated is newly poured in to clean the wafers W. Thus, compared with the technique of replacing deionized water in the treating tank 1 only by overflows, this method provides an improved throughput of cleaning treatment (disclosed in Japanese Unexamined Patent Publication No. 11-214341 (1999), for example).

In time of the quick drainage noted above, the wafers W in the treating tank 1 are exposed to ambient air. When the surfaces of wafers W dry partially, watermarks are formed on the surfaces of wafers W. To avoid drying of the wafers W, as shown in steps S3 and S4 in FIG. 1, the draining of deionized water from the treating tank 1 is followed by what is called “shower cleaning” for spraying deionized water toward the wafers W from the nozzles 51 arranged above the treating tank 1.

However, the conventional example described above is found to have the following drawbacks.

It has been found that the surfaces of substrates cleaned by QDR method are charged with static electricity generated thereon. When the substrate surfaces are charged, particles tend to adhere thereto, and impair effective cleaning treatment as a result. Further, a discharge of static electricity destroys insulating layers on the surfaces of the substrates. Such inconveniences cause pattern defects and have serious influences on the quality of substrates.

### SUMMARY OF THE INVENTION

This invention has been made having regard to the state of the art noted above, and its object is to provide a substrate treating method and apparatus for carrying out cleaning treatment without electrifying substrates.

To fulfill the above object, Inventors have made intensive research.

First, it was confirmed that substrate surfaces after cleaning treatment by the conventional QDR method were electrified to about several volts.

Then, it was found out that, in the series of cleaning steps, the step of spraying deionized water to the substrates after draining deionized water from the treating tank 1 remarkably contributed to an increase in the electrification of substrate surfaces.

This finding will be described in greater detail with reference to FIGS. 2A through 2C. FIG. 2A is a view schematically showing a charge distribution on a surface of a substrate after the substrate is withdrawn up from deionized water in a treating tank without quickly draining the deionized water from the tank and without spraying deionized water to the substrate. FIG. 2B is a view schematically showing a charge distribution on a surface of a substrate after quickly draining deionized water from the treating tank, without spraying deionized water to the substrate. FIG. 2C is a view schematically showing a charge distribution on a surface of a substrate after spraying deionized water to the substrate, without quickly draining the deionized water.

It will be seen from FIGS. 2A and 2B that the step of quickly draining the deionized water from the treating tank 1 somewhat increases electrification of the substrate surface, compared with the case of only immersing the substrate in the deionized water. This is considered due to the friction occurring between the deionized water and the substrate as the water level lowers in time of quick drainage.

FIGS. 2B and 2C show that the step of spraying deionized water to the substrate results in an electrification of the substrate surface about twice as strong as that caused by the step of quickly draining deionized water. This is considered due to a greater friction caused by the sprays of deionized water colliding with and contacting the substrate than the friction accompanying the lowering of the water level in time of quick drainage.

An overall comparison between FIGS. 2A, 2B and 2C proves that, in the series of cleaning steps, the electrification of the substrate surfaces is the strongest when deionized water is sprayed after the quick drainage of deionized water. On the other hand, the electrification caused by the quick draining step, as pointed out heretofore, is only a half of what is caused by the deionized water spraying step, and may be said hardly different from the amount of electrification resulting from the step of only immersing the substrates in the deionized water. Thus, the deionized water spraying step greatly contributes to the increase in electrification.

With these findings, Inventors have completed an invention having the following features.

The invention provides a substrate treating method including a treatment for cleaning substrates with deionized water in a treating tank, the treatment for cleaning with deionized water comprising the steps of:
immersing the substrates in deionized water stored in the treating tank;
draining the deionized water quickly from the treating tank while the substrates are immersed in the deionized water;
supplying the substrates with a treating liquid formed of deionized water and a substance that lowers specific resistance of deionized water, after draining the deionized water quickly or while draining the deionized water quickly; and
supplying deionized water into the treating tank, and immersing the substrates again in the deionized water.

According to this invention, the treating liquid formed of deionized water and a substance that lowers the specific resistance of deionized water has low specific resistance and has conductivity. In the invention recited in claim 1, the treating liquid of low specific resistance is supplied to the substrates, thereby preventing electrification of the substrate surfaces in time of shower cleaning. Consequently, the cleaning treatment may be carried out without electrically charging the substrates.

In the above invention, the step of supplying the substrates with the treating liquid, preferably, is carried out by spraying the treating liquid to the substrates. Then, the treating liquid is effectively supplied to the surfaces of the substrates.

In the above invention, the substance, preferably, is carbon dioxide. The specific resistance may be lowered by mixing and dissolving carbon dioxide in deionized water. With such a treating liquid sprayed to the substrates, the surfaces of the substrates may be prevented from becoming electrically charged in time of shower cleaning.

The above substance may include one of chloride, ammonia and hydrogen peroxide. The specific resistance may be lowered by mixing chloride, ammonia or hydrogen peroxide in deionized water. Also with such a treating liquid sprayed to the substrates, the surfaces of the substrates may be prevented from becoming electrically charged in time of shower cleaning.

In the step of immersing the substrates again in the deionized water, the deionized water may be supplied into the treating tank while the treating liquid is supplied to the substrates at least until the treating tank is filled with the water. This arrangement is effective to avoid the substrates being exposed to ambient air. Thus, the surfaces of the substrates, without becoming dry, are free from water marks formed thereon.

In another aspect of the invention, a substrate treating apparatus is provided for performing a predetermined treatment of substrates. The apparatus comprises:
a treating tank for storing deionized water and immersing the substrates in the deionized water;
a deionized water supply device for supplying the deionized water to the treating tank;
a drain device for draining the deionized water from the treating tank;
a treating liquid forming device for forming a treating liquid having deionized water and a substance that lowers specific resistance of deionized water; and
a treating liquid supply device for supplying the treating liquid formed by the treating liquid forming device to the substrates in the treating tank after the drain device drains the deionized water from the treating tank or while the drain device drains the deionized water from the treating tank.

According to this invention, the treating liquid forming device forms a treating liquid having deionized water and a substance that lowers specific resistance of deionized water. Thus, the treating liquid supplied to the substrates has low specific resistance, and has conductivity. Consequently, the method described above may be implemented advantageously.

The treating liquid supply device may be arranged to spray the treating liquid to the substrates in the treating tank. This construction, with the treating liquid supply device spraying the treating liquid to the substrates in the treating tank, can supply the treating liquid to the surfaces of the substrates effectively.

The treating liquid forming device may be arranged to form the treating liquid by dissolving carbon dioxide in the deionized water as a substance that lowers the specific resistance of the deionized water. The specific resistance may be lowered by mixing and dissolving carbon dioxide in deionized water. Then, the substrates are prevented from becoming electrically charged in time of cleaning with the treating liquid.

The treating liquid forming device may be arranged to form the treating liquid by dissolving one of chloride, ammonia and hydrogen peroxide in the deionized water as a substance that lowers the specific resistance of the deionized water. The specific resistance may be lowered by mixing and dissolving chloride, ammonia or hydrogen peroxide in deionized water. Then, the substrates are prevented from becoming electrically charged in time of cleaning with the treating liquid.

The apparatus according to this invention may further comprise a degassing device connected to the treating liquid forming device for removing gases from the deionized water. With the degassing device removing gases from the deionized water, the substance that lowers the specific resistance of the deionized water may be dissolved effectively in the deionized water.

The degassing device may comprise a vacuum pump. Then, the deionized water may be degassed by decompressing action of the vacuum pump.

The treating liquid supply device may be disposed above the treating tank. Further, the treating liquid supply device may comprise a nozzle defining a plurality of pores. This construction can supply the treating liquid to the surfaces of the substrates effectively.

It is preferred that the substance that lowers the specific resistance is a gas, and the treating liquid forming device comprises a gas-liquid mixer. Where the substance that lowers the specific resistance is a gas, the gas-liquid mixer can form the treating liquid.

Alternatively, the treating liquid supply device may comprise a two-fluid nozzle, the two-fluid nozzle acting as the treating liquid forming device. With this construction, the substance that lowers the specific resistance is mixed in the deionized water within the nozzle, which dispenses with degassing equipment and the like.

The drain device may be arranged to drain the deionized water quickly from the treating tank. By draining the deionized water quickly, chemicals, impurities (particles) and the like separated from the substrates are given less chance of re-adhering to the substrates. The drain device, preferably, includes a drain port disposed in a lowermost position of the treating tank for draining the deionized water from the treating tank. This construction facilitates the quick draining of the deionized water.

The apparatus according to the invention may further comprise a collecting tank disposed around an upper portion of the treating tank, wherein the deionized water supply device is arranged to pour the deionized water in from bottom positions of the treating tank, and the collecting tank is arranged to collect part of the deionized water overflowing the treating tank. With this construction, the deionized water contaminated by particles and the like separated from the substrates does not remain in the treating tank. Thus, the particles and the like are prevented from re-adhering to the substrates.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 (PRIOR ART) is a view showing a procedure of cleaning treatment by QDR method;

FIG. 2A (PRIOR ART) is a view schematically showing a charge distribution on a surface of a substrate after the substrate is withdrawn up from deionized water in a treating tank without quickly draining the deionized water from the tank and without spraying deionized water to the substrate;

FIG. 2B (PRIOR ART) is a view schematically showing a charge distribution on a surface of a substrate after quickly draining deionized water from the treating tank, without spraying deionized water to the substrate;

FIG. 2C (PRIOR ART) is a view schematically showing a charge distribution on a surface of a substrate after spraying deionized water to the substrate, without quickly draining the deionized water;

FIG. 3 is a block diagram showing an outline of a cleaning unit in a substrate treating apparatus according to this invention;

FIG. 4 is a view schematically showing a charge distribution on a surface of a substrate in time of spraying CO₂-impregnated water to the substrate and thereafter immersing and cleaning the substrate in deionized water; and

FIG. 5 is a view schematically showing a charge distribution on a surface of a substrate in time of spraying deionized water to the substrate and thereafter immersing and cleaning the substrate in CO₂-impregnated water.

### DESCRIPTION OF THE PREFERRED EMBODIMENTS

A preferred embodiment of this invention will be described in detail hereinafter with reference to the drawings.

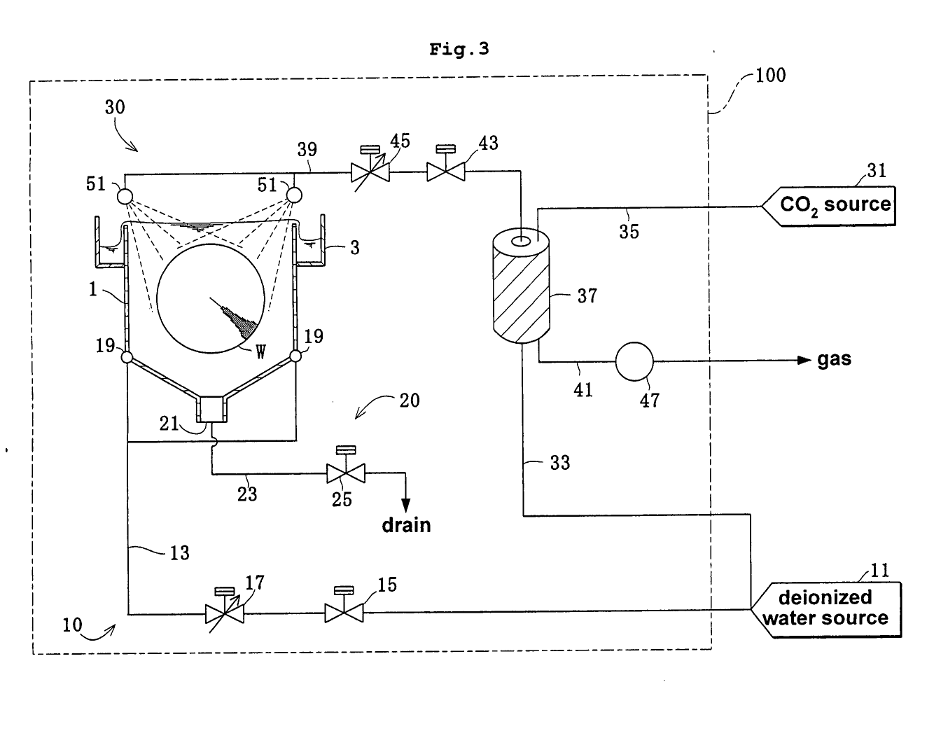

FIG. 3 is a block diagram showing an outline of a cleaning unit in a substrate treating apparatus in one embodiment of this invention

A substrate treating apparatus 100 according to this invention is what is known as the multibath type including a plurality of chemical tanks, not shown, besides the cleaning unit. The substrate treating apparatus 100 successively performs predetermined treatments for groups of substrates. After a chemical treatment, for example, each group of substrates is cleaned in the cleaning unit shown in FIG. 3.

This cleaning unit is a treating unit for exclusive use in cleaning substrates such as semiconductor wafers W, and, broadly, includes a treating tank 1, a deionized water supply device 10, a drain device 20 and a treating liquid forming and spraying device 30.

The treating tank 1 stores deionized water. A plurality of wafers W are immersed and cleaned as a batch in this treating tank 1. The wafers W are carried by a holding arm, not shown, to move vertically into and out of the treating tank 1 and also to other treating units.

The treating tank 1 includes a collecting tank 3 formed around an upper portion thereof. The collecting tank 3 collects deionized water overflowing the treating tank 1.

The deionized water supply device 10 supplies the treating tank 1 with deionized water which is poured in at the bottom of the treating tank 1. The deionized water is supplied from a deionized water source 11 provided as a utility for a factory, for example. A deionized water supply line 13 is connected to the deionized water source 11. The deionized water supply line 13 has, arranged thereon, an electromagnetic switch valve 15, a flow control valve 17, and a filter not shown. Filling pipes 19 communicate with downstream ends of the deionized water supply line 13. The filling pipes 19 are arranged in bottom positions of the treating tank 1 for pouring the deionized water into the treating tank 1. This results in the deionized water overflowing the top of the treating tank 1.

The drain device 20 quickly drains the deionized water from the treating tank 1. The deionized water is drained from the treating tank 1 through a drain port 21. The drain port 21 is disposed in the lowest bottom position of the treating tank 1. A drain pipe 23 is connected to the drain port 21. The drain pipe 23 has an electromagnetic switch valve 25 mounted thereon. The other end of the drain pipe 23 communicates with a drainage treating section not shown. The deionized water stored in the treating tank 1 is quickly drained therefrom by opening the electromagnetic switch valve 25.

The treating liquid forming and spraying device 30 generates a cleaning liquid of low specific resistance, and sprays the treating liquid to the wafers W in the treating tank 1. In this embodiment, the treating liquid is what is called CO₂-impregnated water which is deionized water with carbon dioxide dissolved therein. The deionized water and carbon dioxide are supplied from the deionized water source 11 and a carbon dioxide source 31 provided as utilities of the factory, respectively. The carbon dioxide source 31 may be provided as part of this substrate treating apparatus 100. A deionized water supply line 33 is connected to the deionized water source 11, and a carbon dioxide supply line 35 to the carbon dioxide source 31. The deionized water supply line 33 has an electromagnetic switch valve, not shown, mounted thereon. The carbon dioxide supply line 35 has, mounted thereon, a pressure gauge, a pressure regulating valve and a flow control valve not shown. The other ends of the deionized water supply line 33 and carbon dioxide supply line 35 are connected to a gas-liquid mixer 37. This gas-liquid mixer 37 dissolves the carbon dioxide in the deionized water.

In this embodiment, the gas-liquid mixer 37 has, mounted therein, a gas dissolving membrane not shown. The gas dissolving membrane is formed of a hollow fiber type separation membrane, for example, and has gas permeability and liquid impermeability. The deionized water and carbon dioxide supplied are separated by the gas dissolving membrane. When the pressure of the carbon dioxide is increased higher than the supply pressure of the deionized water, the carbon dioxide permeates through the gas dissolving membrane and dissolves into the deionized water. A degassing region is formed opposite such a deionized water region across another gas dissolving membrane. The degassing region is decompressed by a vacuum pump 47 described hereinafter, to have a lower pressure than the deionized water region. As a result, gases and superfluous carbon dioxide dissolved in the deionized water are removed from the deionized water. In this way, a treating liquid having carbon dioxide dissolved in deionized water is prepared.

Further, in this embodiment, controls are carried out to dissolve a predetermined quantity of carbon dioxide in the deionized water so that the treating liquid has a predetermined specific resistance. Specifically, a control unit, not shown, controls devices and instruments such as the vacuum pump 47 described hereinafter and the flow control valve not shown, to adjust a value of specific resistance of the treating liquid.

A treating liquid supply line 39 and a gas exhaust pipe 41 are connected to the gas-liquid mixer 37.

The treating liquid formed in the gas-liquid mixer 37 is transmitted through the treating liquid supply line 39 to the treating tank 1. The treating liquid supply line 39 has, arranged thereon, an electromagnetic switch valve 43, a flow control valve 45, a carbon dioxide concentration meter not shown, and a specific resistance meter not shown. The treating liquid supply line 39 communicates with nozzles 51 attached to downstream ends thereof. The nozzles 51 are arranged above the treating tank 1 for spraying the treating liquid toward the wafers W in the treating tank 1. In this embodiment, the nozzles 51 are pipe-shaped and each defines a plurality of pores not shown. These nozzles 51 can spray the treating liquid in a shower over the wafers W.

On the other hand, the gases extracted in the gas-liquid mixer 37 are passed into the gas exhaust pipe 41. The vacuum pump 47 and an electromagnetic switch valve not shown are arranged on the gas exhaust pipe 41. Thus, unnecessary gases and the like are discharged from the gas-liquid mixer 37.

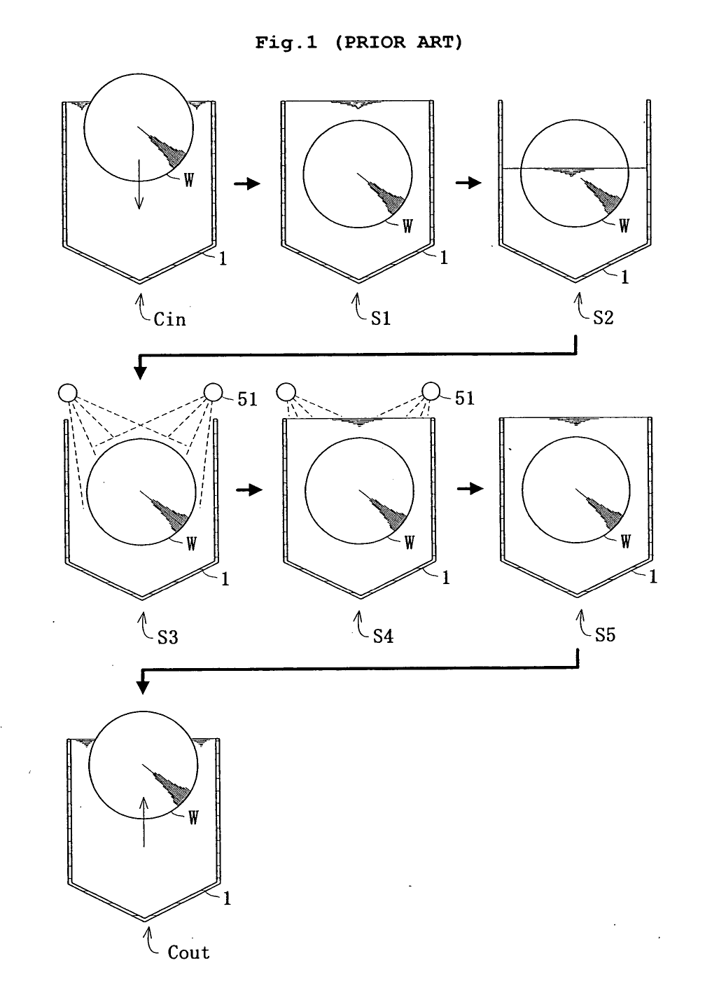

Next, operation of the cleaning unit having the above construction will be described. A procedure of treatment itself is similar to that in the prior art, and thus reference will be made also to FIG. 1.

<Loading Cin>

When a chemical treatment or the like is completed in another treating tank of the substrate treating apparatus 100 in this embodiment, wafers W are transported to the cleaning unit shown in FIG. 3.

The holding arm, not shown, lowers the wafers W into the treating tank 1. The treating tank 1 already stores deionized water supplied from the filling pipes 19, and the wafers W are immersed in the deionized water.

<Step S1: Immersion Cleaning Step>

Deionized water continues to be supplied into the treating tank 1 from the filling pipes 19. With water currents thereby produced, chemicals, particles and so on adhering to the surfaces of wafers W are separated therefrom, and are released into the deionized water. The deionized water contaminated in this way overflows the top of the treating tank 1 to be collected in the collecting tank 3. Thus, the cleaning treatment is performed by washing the chemicals and the like off the surfaces of wafers W out of the treating tank 1.

<Step S2: Quick Draining Step>

After the immersion cleaning step, the electromagnetic switch valve 15 is closed and the electromagnetic switch valve 25 opened. Then, the deionized water in the treating tank 1 is drained quickly from the drain port 21.

<Step S3: Spraying Step>

After the quick draining of the deionized water from the treating tank 1, the electromagnetic switch valve 43 is opened. Then, the treating liquid is sprayed from the nozzles 51 in a shower toward the wafers W.

The treating liquid sprayed has carbon dioxide dissolved in deionized water by the gas-liquid mixer 37. Thus, the treating liquid has a lower specific resistance than deionized water. Usually, deionized water is required to have a specific resistance of at least 18MΩcm. The specific resistance of the treating liquid is 18MΩcm or less.

Therefore, even though the treating liquid supplied collides with and contacts the surfaces of wafers W, static electricity is restrained from generating on the surfaces of wafers W. The surfaces of wafers W are prevented from taking electrical charges in time of shower cleaning.

<Step S4: Spraying and Water Supplying Step>

When the deionized water in the treating tank 1 has been drained completely, the electromagnetic switch valve 25 is closed, and the electromagnetic switch valve 15 is opened to pour deionized water again from the filling pipes 19 into the treating tank 1. The spraying of the treating liquid is continued even after the treating tank 1 is filled with deionized water, until elapse of a predetermined time.

<Step S5: Immersion Cleaning Step>

Subsequently, the electromagnetic switch valve 43 is closed to end the spraying of the treating liquid, and then only an immersion cleaning is performed for the wafers W. This immersion cleaning step is ended when the wafers W are fully cleaned. In this embodiment, the end of cleaning treatment is determined by confirming with the specific resistance meter, not shown, that the specific resistance of the deionized water in the treating tank 1 has reached a preset value. This completes the cleaning treatment based on the series of steps.

<Unloading Cout>

The holding arm not shown moves upward to take the wafers W out of the treating tank 1, and transports the wafers W to a next, drying unit, for example.

<Comparison between Invention and Prior Art—1>

Checking has been made to determine whether this invention, compared with the prior art, is effective for preventing electrification of the surfaces of wafers W.

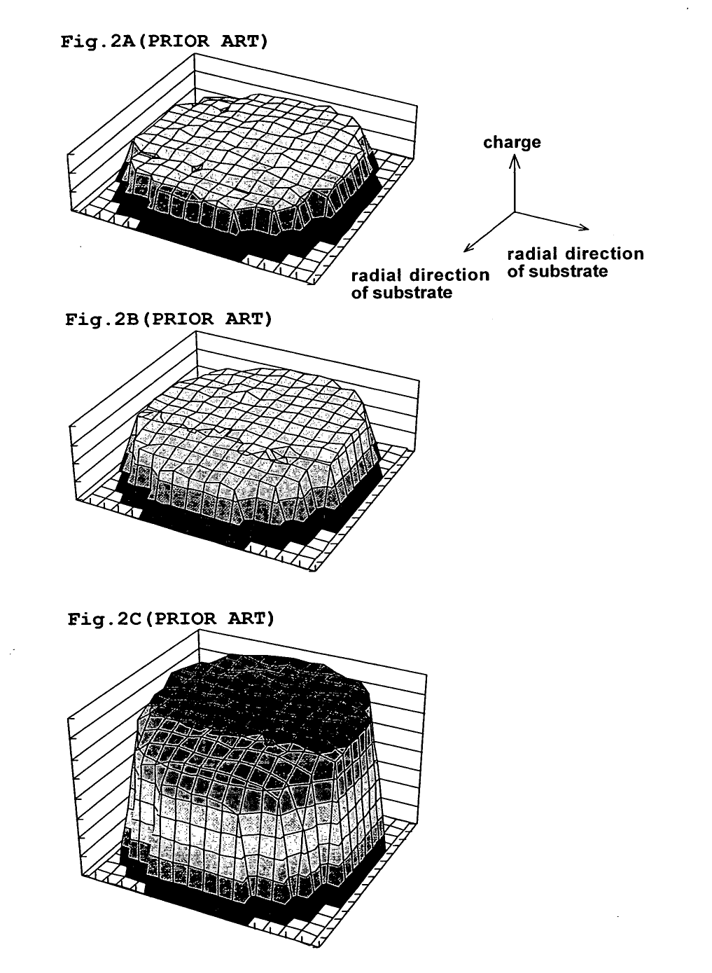

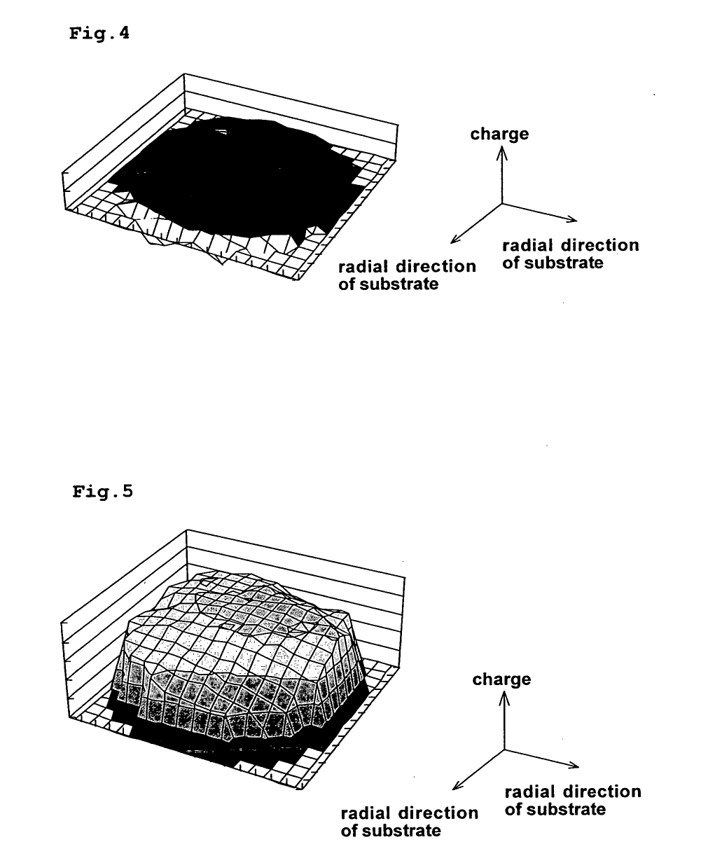

FIG. 4 is a view schematically showing a charge distribution on a surface of a substrate in time of spraying CO₂-impregnated water to the substrate and thereafter immersing and cleaning the substrate in deionized water. It is FIG. 2C illustrating the prior art that is to be contrasted with FIG. 4.

These examples are based on the same conditions except that the liquid sprayed to the substrate in FIG. 4 is CO₂-impregnated water, while deionized water is sprayed to the substrate shown in FIG. 2C.

A comparison between FIG. 4 and FIG. 2C shows that the level of electrification in time of spraying CO₂-impregnated water is approximately 10% of what it is in time of spraying deionized water. Thus, it has been confirmed that this embodiment, compared with the prior art, is effective to prevent the surfaces of wafers W from taking electrical charges in time of shower cleaning. This is considered due to the CO₂-impregnated water having low specific resistance and conductivity, and therefore restraining generation of static electricity when colliding with and contacting the wafers W.

<Comparison between Invention and Prior Art—2>

As a known method of performing cleaning treatment without electrifying the surfaces of wafers W, the deionized water poured from the filling pipes 17 into the treating tank 1 is changed to CO₂-impregnated water, for example. Such a cleaning method is compared with this invention illustrated in FIG. 4.

FIG. 5 is a view schematically showing a charge distribution on a surface of a substrate in time of spraying deionized water to the substrate and thereafter immersing and cleaning the substrate in CO₂-impregnated water.

The two examples are based on the same conditions except that CO₂-impregnated water is sprayed to the substrate in FIG. 4, while CO₂-impregnated water is poured into the treating tank 1 in the case of the substrate shown in FIG. 5.

A comparison between FIG. 4 and FIG. 5 shows that the level of electrification in time of spraying CO₂-impregnated water to the wafers W and then immersing the wafers W in deionized water as in this embodiment (FIG. 4) is approximately 20% of what it is in time of spraying deionized water to the wafers W and then immersing the wafers W in CO₂-impregnated water (FIG. 5). Thus, this embodiment, compared with the prior art, is said effective to prevent the surfaces of wafers W from taking electrical charges in time of shower cleaning, by effectively using CO₂-impregnated water.

This is considered due to the effect of using CO₂-impregnated water in the spraying step tending to generate a large amount of static electricity, thereby precluding the possibility of electrifying the surfaces of wafers W.

The surface of the substrate shown in FIG. 5 is considered to take electrical charges when deionized water is sprayed to the substrate. Once static electricity is permitted to generate on the surface of the substrate by the spraying of deionized water, it can be said difficult to discharge the electricity even if the substrate is subsequently immersed in CO₂-impregnated water.

According to this invention, on the other hand, the substrate is not electrified in time of shower cleaning since the treating liquid of low specific resistance is used as a liquid sprayed to the substrate. Consequently, the substrate is free from adhesion of particles and the like, and from dielectric breakdown caused by electric discharge.

The treating liquid used in the spraying step may be smaller in quantity than the deionized water supplied to the treating tank. Thus, the consumption of carbon dioxide may be reduced, compared with the prior art which supplies CO₂-impregnated water to the treating tank. This provides an advantage of reduced running cost.

Next, other advantages of this embodiment are set out hereunder.

First, the use of carbon dioxide as a substance dissolved in deionized water provides advantages of being easy to dissolve in deionized water, having little influence on the wafers W, and realizing equipment including utilities safely and at low cost. The use of gas-liquid mixer 37 to form CO₂-impregnated water as the treating liquid enables the value of specific resistance of the treating liquid to be maintained constant or varied with ease.

This invention is not limited to the above embodiment, but may be modified as follows:
(1) In the embodiment described above, carbon dioxide is dissolved in deionized water. The invention is not limited to the use of carbon dioxide, but may use any substance that lowers the specific resistance of deionized water. For example, a chemical such as chloride, ammonia or hydrogen peroxide may be mixed in a small quantity into deionized water. Further, the treating liquid may be ozone water or what is called functional water.

Where chloride, ammonia or hydrogen peroxide is mixed into deionized water, the gas-liquid mixer 37 and degassing equipment associated therewith are not required. For example, a line for supplying a solution of such a substance may be arranged to communicate with the deionized water supply line 33 through a mixing valve for mixing the solution with deionized water.
(2) The embodiment described above includes the gas-liquid mixer 37 for dissolving carbon dioxide in deionized water. The invention is not limited to this construction, but may employ any device that can dissolve carbon dioxide in deionized water. For example, what is called a bubbling tank that supplies carbon dioxide directly into deionized water may be used to form CO₂-impregnated water.

Each nozzle 51 may be what is called a two-fluid nozzle to dissolve carbon dioxide directly in deionized water within the nozzle. This construction can dispense with the equipment for degassing the treating liquid.
(3) In the embodiment described above, the substrate treating apparatus 100 is what is called the multibath type. The apparatus is not limited to this, but may be the one-bath type. In this case, the treating tank 1 is used to give the substrates chemical treatment before the cleaning treatment with deionized water.
(4) In the described embodiment, CO₂-impregnated water is sprayed toward the substrates after quickly draining the deionized water from the treating tank 1. Instead, CO₂-impregnated water may be sprayed toward the substrates while quickly draining the deionized water from the treating tank 1. This may prove effective to suppress the electrification caused by the quick draining of the deionized water.

This invention may be embodied in other specific forms without departing from the spirit or essential attributes thereof and, accordingly, reference should be made to the appended claims, rather than to the foregoing specification, as indicating the scope of the invention.

1. A substrate treating method including a treatment for cleaning substrates with deionized water in a treating tank, said treatment for cleaning with deionized water comprising the steps of:
immersing said substrates in deionized water stored in said treating tank;
draining the deionized water quickly from said treating tank while the substrates are immersed in the deionized water;
supplying the substrates with a treating liquid formed of deionized water and a substance that lowers specific resistance of deionized water, after draining the deionized water quickly or while draining the deionized water quickly; and
supplying deionized water into said treating tank, and immersing the substrates again in the deionized water.

2. A method as defined in claim 1, wherein the step of supplying the substrates with said treating liquid is carried out by spraying the treating liquid to the substrates.

3. A method as defined in claim 1, wherein said substance is carbon dioxide.

4. A method as defined in claim 1, wherein said substance includes one of chloride, ammonia and hydrogen peroxide.

5. A method as defined in claim 1, wherein, in the step of immersing the substrates again in the deionized water, the deionized water is supplied into said treating tank while the treating liquid is supplied to the substrates at least until the treating tank is filled with the water.

6. A substrate treating apparatus for performing a predetermined treatment of substrates, comprising:
a treating tank for storing deionized water and immersing the substrates in the deionized water;
deionized water supply means for supplying the deionized water to said treating tank;
drain means for draining the deionized water from said treating tank;
treating liquid forming means for forming a treating liquid having deionized water and a substance that lowers specific resistance of deionized water; and
treating liquid supply means for supplying the treating liquid formed by said treating liquid forming means to the substrates in said treating tank after said drain means drains the deionized water from said treating tank or while said drain means drains the deionized water from said treating tank.

7. An apparatus as defined in claim 6, wherein said treating liquid supply means is arranged to spray the treating liquid to the substrates in said treating tank.

8. An apparatus as defined in claim 6, wherein said treating liquid forming means is arranged to form the treating liquid by dissolving carbon dioxide in the deionized water as a substance that lowers the specific resistance of the deionized water.

9. An apparatus as defined in claim 6, wherein said treating liquid forming means is arranged to form the treating liquid by dissolving one of chloride, ammonia and hydrogen peroxide in the deionized water as a substance that lowers the specific resistance of the deionized water.

10. An apparatus as defined in claim 8, further comprising degassing means connected to said treating liquid forming means for removing gases from the deionized water.

11. An apparatus as defined in the claim 10, wherein said degassing means comprises a vacuum pump.

12. An apparatus as defined in claim 9, further comprising degassing means connected to said treating liquid forming means for removing gases from the deionized water.

13. An apparatus as defined in claim 12, wherein said degassing means comprises a vacuum pump.

14. An apparatus as defined in claim 6, wherein said treating liquid supply means is disposed above said treating tank.

15. An apparatus as defined in claim 6, wherein said treating liquid supply means comprises a nozzle defining a plurality of pores.

16. An apparatus as defined in claim 6, wherein said substance that lowers the specific resistance is a gas, and said treating liquid forming means comprises a gas-liquid mixer.

17. An apparatus as defined in claim 6, wherein said treating liquid supply means comprises a two-fluid nozzle, said two-fluid nozzle acting as the treating liquid forming means.

18. An apparatus as defined in claim 6, wherein said drain means is arranged to drain the deionized water quickly from the treating tank.

19. An apparatus as defined in claim 18, wherein said drain means includes a drain port disposed in a lowermost position of the treating tank for draining the deionized water from the treating tank.

20. An apparatus as defined in claim 6, further comprising a collecting tank disposed around an upper portion of the treating tank, wherein said deionized water supply means is arranged to pour the deionized water in from bottom positions of the treating tank, and said collecting tank is arranged to collect part of the deionized water overflowing the treating tank.
